(19) United States
(12) Patent Application Publication
(10) Pub. No.: US 2026/0186333 A1
(43) Pub. Date: Jul. 2, 2026

(54) DISPLAY DEVICE

(71) Applicant: AUO Corporation, Hsinchu City (TW)

(72) Inventors: Tsi-Hsuan Hsu, Hsinchu City (TW); Kun-Lung Hsieh, Hsinchu City (TW)

(73) Assignee: AUO Corporation, Hsinchu City (TW)

(21) Appl. No.: 19/235,532

(22) Filed: Jun. 11, 2025

(30) Foreign Application Priority Data
Dec. 31, 2024 (TW) 113151637

(51) Int. Cl. G02F 1/1333

(52) U.S. Cl. CPC G02F 1/133305; G02F 1/133331; G02F 2201/50; G02F 2202/28

(57) ABSTRACT

A display device includes a flexible display panel, a substrate, a cover plate, a first connecting element, and a first adhesive layer. Substrate is located on a bottom side of the panel and has a normal direction and first and second directions perpendicular to normal direction. First direction is perpendicular to second direction. The plate is located on a top side of the panel. The layer is located between the plate and the panel. Extending direction of two first side edges of the panel are parallel to second direction. A bending axis of the panel is parallel to first direction, and a display surface of the panel protrudes outward away from substrate. The layer includes two opposite third side edges, and the two third side edges are parallel and flush with the two first side edges. In first direction, length of the plate is greater than length of the layer.

### CROSS-REFERENCE TO RELATED APPLICATION

This application claims the priority benefit of Taiwan application serial no. 113151637, filed on Dec. 31, 2024. The entirety of the above-mentioned patent application is hereby incorporated by reference herein and made a part of this specification.

### BACKGROUND

### Technical Field

The disclosure relates to a display device, and particularly relates to a display device including a flexible display panel.

### Related Art

Generally speaking, when a flexible display dynamically folds, rolls, or slides, an adhesive material is prone to peeling. Even when the flexible display is in a static fixed curve, when a curvature radius of a folding angle is too small, the adhesive material is also prone to peeling. The peeling of the adhesive material may be separation from upper and lower materials, or internal separation within the adhesive material itself.

### SUMMARY

The disclosure provides a display device, which may avoid adhesive material peeling, thereby improving yield.

The display device of the disclosure includes a flexible display panel, a substrate, a cover plate, a first connecting element, and a first adhesive layer. The flexible display panel has a top side and a bottom side opposite to each other. The substrate is located at the bottom side and has a normal direction and a first direction and a second direction perpendicular to the normal direction. The first direction is perpendicular to the second direction. The cover plate is located at the top side. The first connecting element is located between the substrate and the flexible display panel. The first adhesive layer is located between the cover plate and the flexible display panel. The flexible display panel includes two opposite first side edges and two opposite second side edges. An extending direction of the two first side edges parallel to the second direction, and an extending direction of the two second side edges parallel to the first direction. A bending axis of the flexible display panel is parallel to the first direction and a display surface of the flexible display panel is adapted to protrude outward in a direction away from the substrate. The first adhesive layer includes two opposite third side edges, and the two third side edges are parallel and flush with the two first side edges. In the first direction, a length of the cover plate is greater than a length of the first adhesive layer.

In an embodiment of the disclosure, in the first direction, the length of the cover plate is greater than a length of the substrate.

In an embodiment of the disclosure, a length of the first connecting element is smaller than or equal to a length of the flexible display panel.

In an embodiment of the disclosure, a length of the first connecting element is smaller than or equal to a length of the substrate.

In an embodiment of the disclosure, a length of the first connecting element is smaller than or equal to the length of the first adhesive layer.

In an embodiment of the disclosure, a storage modulus of the first adhesive layer is between 20% and 60% of a storage modulus of the first connecting element.

In an embodiment of the disclosure, the display device further includes a bonding layer, located on the cover plate. In the first direction and the second direction, a length of the bonding layer is greater than the length of the first adhesive layer, the length of the bonding layer is greater than a length of the first connecting element, and the length of the bonding layer is greater than the length of the cover plate.

In an embodiment of the disclosure, the display device further includes a protective element. The bonding layer is located between the protective element and the cover plate.

In an embodiment of the disclosure, the display device further includes a second connecting element and a back film. The second connecting element is located between the bottom side and the first connecting element. The back film is located between the second connecting element and the first connecting element.

In an embodiment of the disclosure, the display device further includes a touch panel and a second adhesive layer. The touch panel is located on the first adhesive layer. The touch panel includes two opposite fourth side edges, the two fourth side edges are parallel and flush with the first side edge. The second adhesive layer is located between the touch panel and the cover plate. In the first direction, a length of the second adhesive layer is equal to the length of the first adhesive layer.

In an embodiment of the disclosure, in the second direction, a length of the flexible display panel is greater than a length of the second adhesive layer, the first adhesive layer, and the touch panel.

In an embodiment of the disclosure, in the second direction, a length of the touch panel is greater than the length of the second adhesive layer.

In an embodiment of the disclosure, in the first direction and the second direction, the length of the second adhesive layer is greater than or equal to the length of the first connecting element.

In an embodiment of the disclosure, a storage modulus of the first adhesive layer is smaller than a storage modulus of the second adhesive layer, and the storage modulus of the second adhesive layer is smaller than a storage modulus of the second connecting element.

In an embodiment of the disclosure, a storage modulus of the first adhesive layer is smaller than a storage modulus of the second adhesive layer, and the storage modulus of the second adhesive layer is smaller than a storage modulus of the first connecting element.

In an embodiment of the disclosure, the display device further includes a shield element, configured on the cover plate. A thickness of the bonding layer in the normal direction is greater than a thickness of the second adhesive layer in the normal direction.

In an embodiment of the disclosure, the display device further includes a shield element, configured under the cover plate. A thickness of the second adhesive layer in the normal direction is greater than a thickness of the bonding layer in the normal direction.

In an embodiment of the disclosure, a storage modulus of the first adhesive layer is between 20% and 60% of a storage modulus of the second connecting element.

Based on the above, in the display device of the disclosure, the flexible display panel may be adapted to protrude upward. The first adhesive layer above the flexible display panel includes two opposite third side edges, and the two third side edges are parallel and flush with two first side edges of the flexible display panel. Thereby, when folding, the first adhesive layer completely secures the flexible display panel on an upper material. Therefore, the flexible display panel is less likely to pull the first adhesive layer to cause peeling of the first adhesive layer, thus improving yield.

The accompanying drawings are included to provide a further understanding of the disclosure, and are incorporated in and constitute a part of this specification. The drawings illustrate embodiments of the disclosure and, together with the description, serve to explain the principles of the disclosure.

### BRIEF DESCRIPTION OF THE DRAWINGS

FIG. 1A and FIG. 1B are perspective schematic diagrams of a display device according to an embodiment of the disclosure applied to a seat.

FIG. 2A and FIG. 2B are schematic diagrams of bending methods of display devices according to some embodiments of the disclosure.

FIG. 3 is a front-view schematic diagram of a display device according to an embodiment of the disclosure.

FIG. 4 is a cross-sectional schematic diagram of a display device according to an embodiment of the disclosure.

FIG. 5A and FIG. 5B are operational schematic diagrams of a display device according to an embodiment of the disclosure.

FIG. 6A and FIG. 6B are cross-sectional schematic diagrams of a display device according to an embodiment of the disclosure at different section lines.

FIG. 7A is a cross-sectional schematic diagram of a display device according to an embodiment of the disclosure.

FIG. 7B is a cross-sectional schematic diagram of a display device according to an embodiment of the disclosure.

### DESCRIPTION OF THE EMBODIMENTS

In the following, the disclosure will be described more comprehensively with reference to the accompanying drawings, in which exemplary embodiments of the disclosure are shown. As those skilled in the art will recognize, the described embodiments may be modified in various different ways without departing from the spirit or scope of the disclosure.

In the drawings, the thickness of layers, films, panels, regions, etc. are exaggerated for clarity. Throughout the specification, the same reference numerals denote the same elements. It should be understood that when an element such as a layer, film, region, or substrate is referred to as being “on” or “connected to” another element, it may be directly on or connected to the other element, or intervening elements may be present. In contrast, when an element is referred to as being “directly on” or “directly connected to” another element, no intervening elements are present. As used herein, “connected” may refer to physical and/or electrical connection. Furthermore, “electrical connection” or “coupling” may be that there are other elements existing between two components.

In addition, relative terms such as “lower” or “bottom” and “upper” or “top” may be used herein to describe the relationship of one element to another element, as shown in the drawings. It should be understood that the relative terms are intended to include different orientations of the device in addition to the orientation shown in the drawings. For example, if a device in a drawing is turned over, an element having been described as being on the “lower” side of another element would then be oriented on the “upper” side of that another element. Thus, the exemplary term “lower” may include both “lower” and “upper” orientations, depending on the particular orientation of the drawing. Similarly, if a device in a drawing is turned over, an element having been described as being “below” or “under” another element would then be oriented as being “above” that another element. Thus, the exemplary terms “above” or “below” may include both the orientation of above and below.

The terms “about,” “approximately,” or “substantially” as used herein include the stated value and average value within an acceptable deviation range for a particular value as determined by ordinary skilled persons in the art, taking into consideration the particular amount of the measurements in question and errors associated with the measurements (i.e. limitations of the measurement system). For example, “about” may indicate within one or more standard deviations of the stated value, or within ±30%, ±20%, ±10%, ±5%. Furthermore, “about,” “approximately,” or “substantially” as used herein may select more acceptable deviation ranges or standard deviations according to optical properties, etching properties, or other properties, rather than using one standard deviation applicable to all properties.

Exemplary embodiments are described herein with reference to cross-sectional schematic drawings that serve as idealized embodiments. As such, variations from the shapes of the drawings as a result of, for example, manufacturing techniques and/or tolerances, may be expected. Thus, embodiments described herein should not be construed as limited to the particular shapes of regions as illustrated herein but are to include deviations in shapes that result, for example, from manufacturing. For example, a region illustrated or described as flat may typically have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the disclosure, and will not be interpreted in an idealized or overly formal sense unless expressly so defined herein.

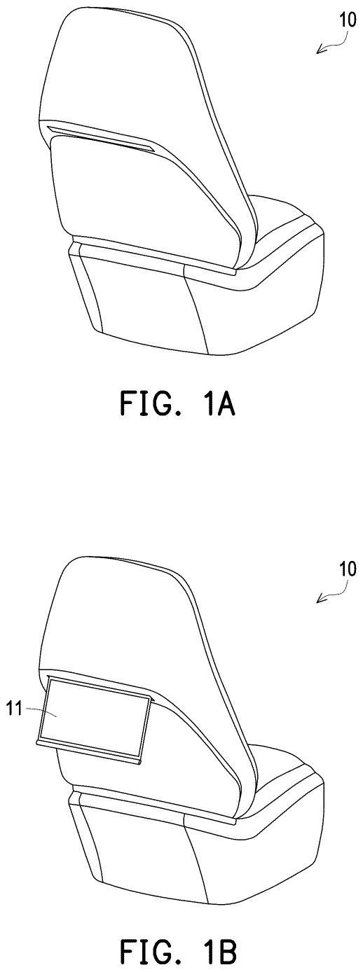

FIG. 1A and FIG. 1B are perspective schematic diagrams of a display device according to an embodiment of the disclosure applied to a seat. With the development of automotive industry and technology, users' demands for in-car audio-visual entertainment have continuously increased. Referring to FIG. 1A and FIG. 1B, for example, a display device 11 configured at the back of a front seat 10 may provide entertainment experience for rear passengers. Note that FIG. 1A and FIG. 1B respectively illustrate the storage and deployment states of the display device 11 applied to the seat 10, but the disclosure is not limited thereto.

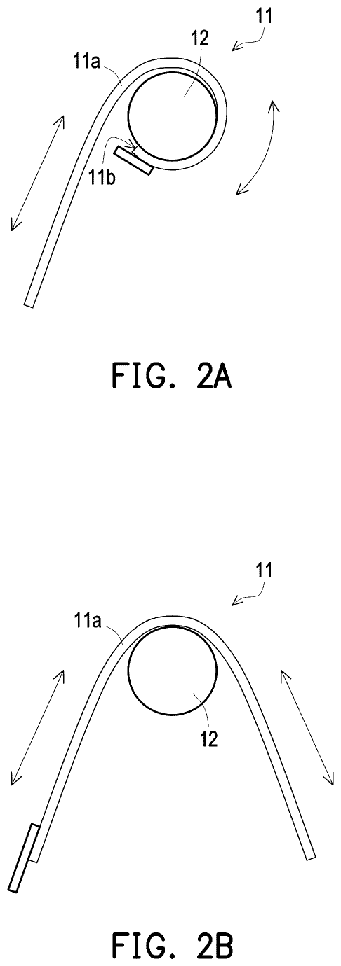

FIG. 2A and FIG. 2B are schematic diagrams of bending methods of display devices according to some embodiments of the disclosure. Referring to FIG. 2A and FIG. 2B, for example, the display device 11 of FIG. 1A and FIG. 1B may utilize a roller 12 to fold a flexible display panel 11a of the display device 11 as shown in FIG. 2A, or slide it as shown in FIG. 2B, but the disclosure is not limited thereto. In one embodiment, an edge 11b of the flexible display panel 11a shown in FIG. 2A is connected to the roller 12, and the roller 12 is adapted to deploy or roll up the flexible display panel 11a, but the disclosure is not limited thereto.

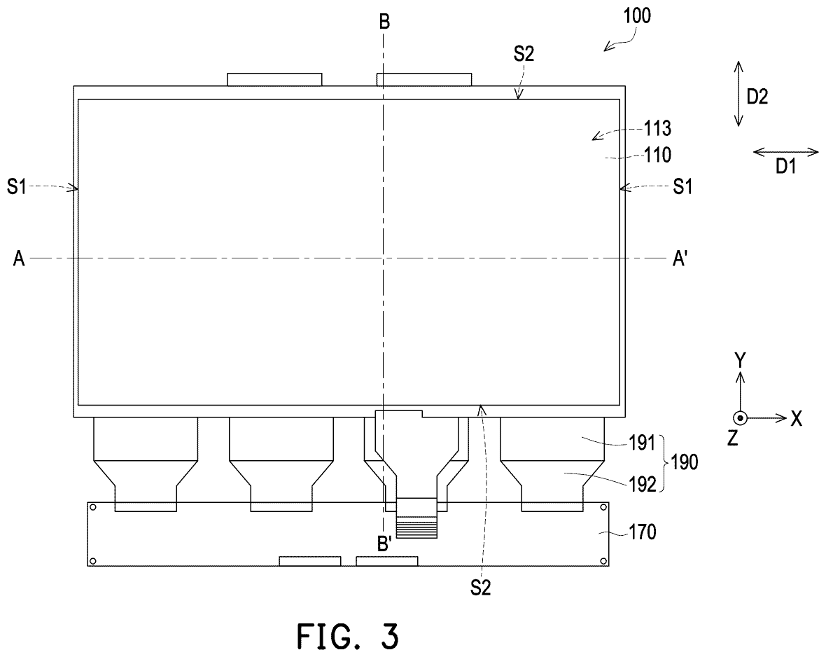

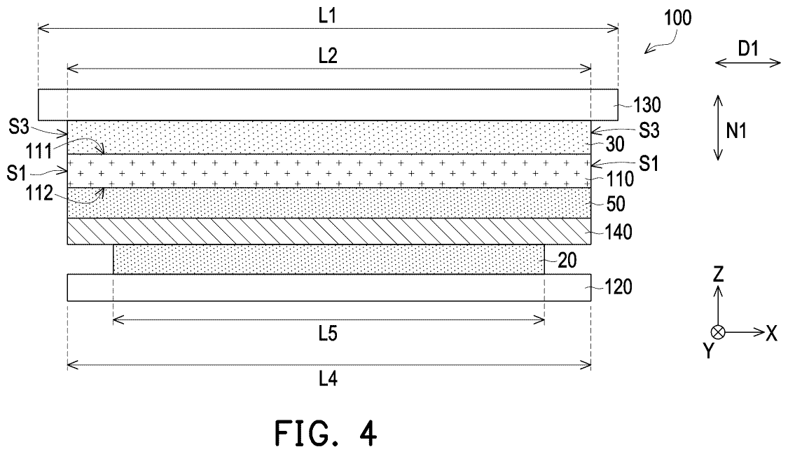

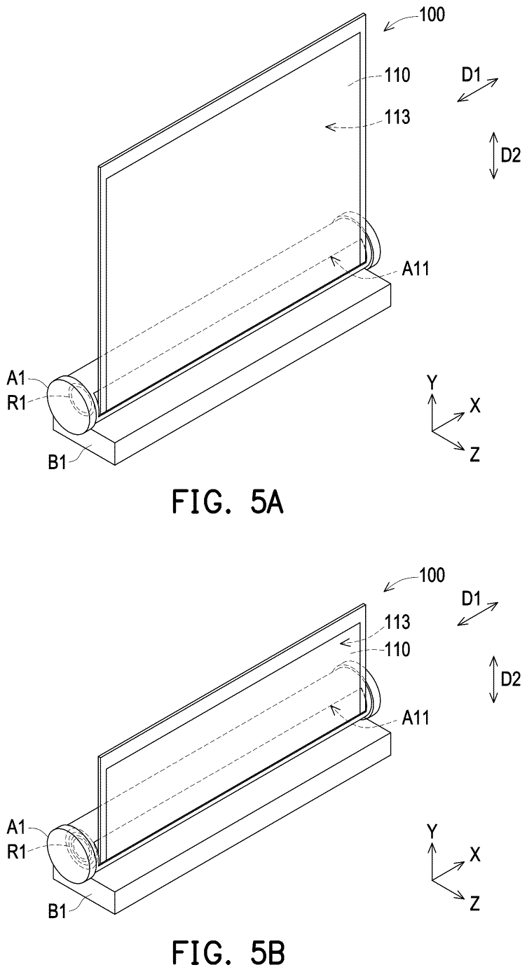

FIG. 3 is a front-view schematic diagram of a display device according to an embodiment of the disclosure. FIG. 4 is a cross-sectional schematic diagram of a display device according to an embodiment of the disclosure. FIG. 5A and FIG. 5B are operational schematic diagrams of a display device according to an embodiment of the disclosure. Note that FIG. 4 illustrates a cross-sectional schematic view of a display device 100 at section line A-A′ in FIG. 3. Rectangular coordinates X-Y-Z are provided simultaneously herein to facilitate subsequent description and reference of related elements.

Referring to FIG. 3 and FIG. 4, the display device 100 of this embodiment includes a substrate 120, a first connecting element 20, a back film 140, a second connecting element 50, a flexible display panel 110, a first adhesive layer 30, and a cover plate 130. The substrate 120, the first connecting element 20, the back film 140, the second connecting element 50, the flexible display panel 110, the first adhesive layer 30, and the cover plate 130 are sequentially stacked in the Z direction. The display device 100 is adapted to protrude outward in the positive Z direction, but the disclosure is not limited thereto.

In this embodiment, the flexible display panel 110 has a top side 111 and a bottom side 112 opposite to each other. The substrate 120 is located at the bottom side 112 of the flexible display panel 110. Specifically, the substrate 120 has a normal direction N1, a first direction D1 perpendicular to the normal direction N1, and a second direction D2 perpendicular to the normal direction N1 (FIG. 3). The first direction D1 is perpendicular to the second direction D2. Here, the first direction D1 is, for example, parallel to the X direction, the second direction D2 is, for example, parallel to the Y direction, and the normal direction N1 is, for example, parallel to the Z direction.

In this embodiment, the first connecting element 20 is located between the substrate 120 and the flexible display panel 110, and the first adhesive layer 30 is located between the cover plate 130 and the flexible display panel 110.

In this embodiment, the flexible display panel 110 is adapted to protrude outward in the positive Z direction, and the adhesive material on the top side 111 of the flexible display panel 110 needs to withstand greater shear strain, therefore placing adhesive material with smaller storage modulus at positions that need to withstand greater shear strain reduces the chances of peeling when the adhesive material bends. Therefore, the storage modulus of the first adhesive layer 30 above the flexible display panel 110 needs to be smaller than the storage modulus of the first connecting element 20 and the second connecting element 50 below the flexible display panel 110. For example, the storage modulus of the first adhesive layer 30 is between 20% and 60% of the storage modulus of the first connecting element 20, and the storage modulus of the first adhesive layer 30 is between 20% and 60% of the storage modulus of the second connecting element 50, which reduced the chances of peeling of the first adhesive layer 30, and avoid excessive differences in material properties, but the disclosure is not limited thereto.

In this embodiment, the first adhesive layer 30 above the flexible display panel 110 may be a thin film-like Optical Clear Adhesive (OCA) or a liquid-state optical clear resin. In other embodiments, the first adhesive layer 30 may also be a non-transparent color; there is no limitation in the disclosure.

In this embodiment, the first connecting element 20 and the second connecting element 50 below the flexible display panel 110 may be Pressure Sensitive Adhesive (PSA), double-sided tape, or an adhesive element with a base material in the middle, which are easy to attach and are inexpensive. In other embodiments, the first connecting element 20 and the second connecting element 50 may also be OCA; the disclosure is not limited thereto.

In this embodiment, the cover plate 130 is located at the top side 111 of the flexible display panel 110, the second connecting element 50 is located between the bottom side 112 of the flexible display panel 110 and the first connecting element 20, and the back film 140 is located between the second connecting element 50 and the first connecting element 20. The flexible display panel 110 is adhered to the cover plate 130 using the first adhesive layer 30, the back film 140 is adhered to the flexible display panel 110 using the second connecting element 50, and the substrate 120 is adhered to the back film 140 using the first connecting element 20, but the disclosure is not limited thereto.

Here, the cover plate 130 may be a plate-shaped body made of glass, such as Ultra-Thin Glass (UTG), but the disclosure is not limited thereto. Here, the back film 140 may be a heat dissipation sheet or a plastic sheet (PET); the disclosure is not limited thereto.

In one embodiment, the back film 140, the second connecting element 50, the flexible display panel 110, and the first adhesive layer 30 below the cover plate 130 may be cut flush, for example, by cutting along a first side edge S1 of the flexible display panel 110 using a cutting tool to achieve a flush-cut effect and to improve process convenience, thereby the back film 140, the second connecting element 50, the flexible display panel 110, and the first adhesive layer 30 have a same length L2 in the first direction D1.

Specifically, in this embodiment, the flexible display panel 110 includes two opposite first side edges S1, and the extending direction of the two first side edges S1 is parallel to the second direction D2 (that is, the Y direction). The first adhesive layer 30 includes two opposite third side edges S3, and the two third side edges S3 are parallel and cut flush with the first side edges S1.

In this embodiment, in the first direction D1, a length L1 of the cover plate 130 is greater than the length L2 of the first adhesive layer 30. In this way, the larger cover plate 130 can achieve protective function and aesthetic effect.

In this embodiment, the bending axis of the flexible display panel 110 is parallel to the first direction D1, and a display surface 113 (FIG. 3) of the flexible display panel 110 corresponding to the top side 111 is adapted to protrude outward in a direction away from the substrate 120, to serve as a protruding display. As shown in FIG. 5A and FIG. 5B, in one embodiment, the display device 100 further includes a housing A1 and a base B1 for carrying the housing A1. The housing A1 has an opening A11, and a roller shaft R1 is located inside the housing A1. The flexible display panel 110 may be expanded or stored by folding, but the disclosure is not limited thereto. In one embodiment, the housing A1 and the base B1 may be installed on the seat 10 in FIG. 1A, but the disclosure is not limited thereto.

Under the configuration, the size of the display screen of the flexible display panel 110 may be adjusted according to the usage scenario, which is extremely convenient. In particular, as shown in FIG. 4, in the first direction D1, the first adhesive layer 30 (the adhesive material closest to the flexible display panel 110) and the flexible display panel 110 have the same length. Thereby, when folding, the first adhesive layer 30 completely secures the flexible display panel 110 to the upper material (such as the cover plate 130). Therefore, the flexible display panel 110 is less likely to pull the first adhesive layer 30 to cause peeling of the first adhesive layer 30, thus improving the yield of the display device 100.

Referring to FIG. 4, in this embodiment, the substrate 120 may be a SUS stainless steel plate, but the disclosure is not limited thereto. In the first direction D1, the length L1 of the cover plate 130 is greater than a length L4 of the substrate 120, to avoid interference with the underlying mechanism and to maintain appearance.

In one embodiment, the assembly sequence of the display device 100 may be to first configure the back film 140, the second connecting element 50, the flexible display panel 110, and the first adhesive layer 30 below the cover plate 130, and then adhere the substrate 120 to the back film 140 through the first connecting element 20. At this point, to avoid the first connecting element 20 from being exposed or stretched due to excessive length, the first connecting element 20 is designed to be recessed. That is, in the first direction D1, a length L5 of the first connecting element 20 is smaller than the length L2 of the flexible display panel 110 and the first adhesive layer 30 above it, and the length L5 of the first connecting element 20 is smaller than the length L4 of the substrate 120 below it, but the disclosure is not limited thereto.

In other embodiments, the substrate may also be cut flush with the flexible display panel. Thereby, the length of the first connecting element may be equal to the length of the flexible display panel and the first adhesive layer above it; there is no limitation in the disclosure.

In this embodiment, in the first direction D1, the length L4 of the substrate 120 is equal to the length L2 of the flexible display panel 110, but in other embodiments, in the first direction, the length of the substrate may also be smaller than or equal to the length of the flexible display panel, the disclosure is not limited thereto.

In addition, referring to FIG. 3, the display device 100 further includes a circuit board 170 and a flexible circuit base material 190. The flexible circuit base material 190 includes a driving chip 191 and a flexible circuit board 192, but the disclosure is not limited thereto. The driving chip 191 may be configured to provide the electrical signals required by the display medium on the flexible display panel 110, but the disclosure is not limited thereto.

The following will list other embodiments for illustration. It must be explained that the following embodiments use the reference numerals and partial content of the aforementioned embodiments, where the same reference numerals are used to represent the same or similar elements, and descriptions of identical technical content are omitted. For description of the omitted parts, please refer to the aforementioned embodiments, and the following embodiments will not repeat them.

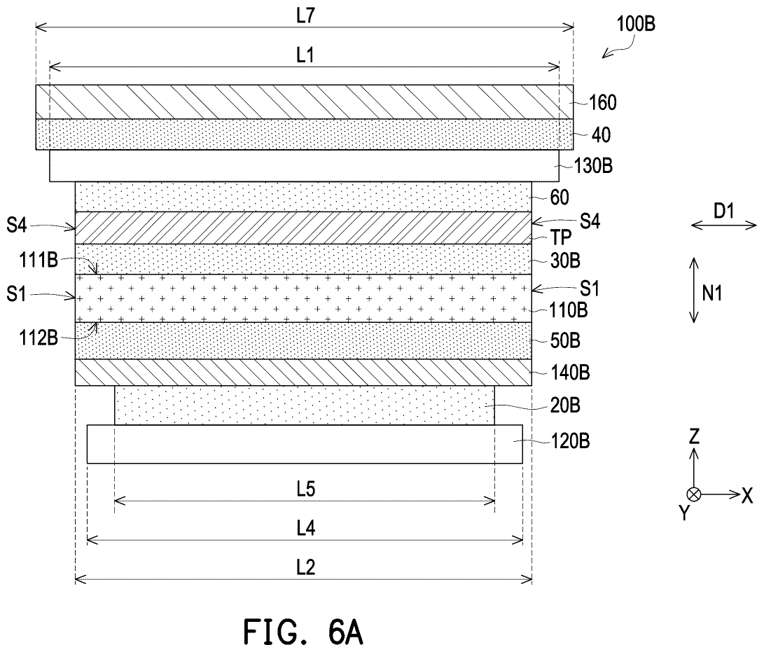

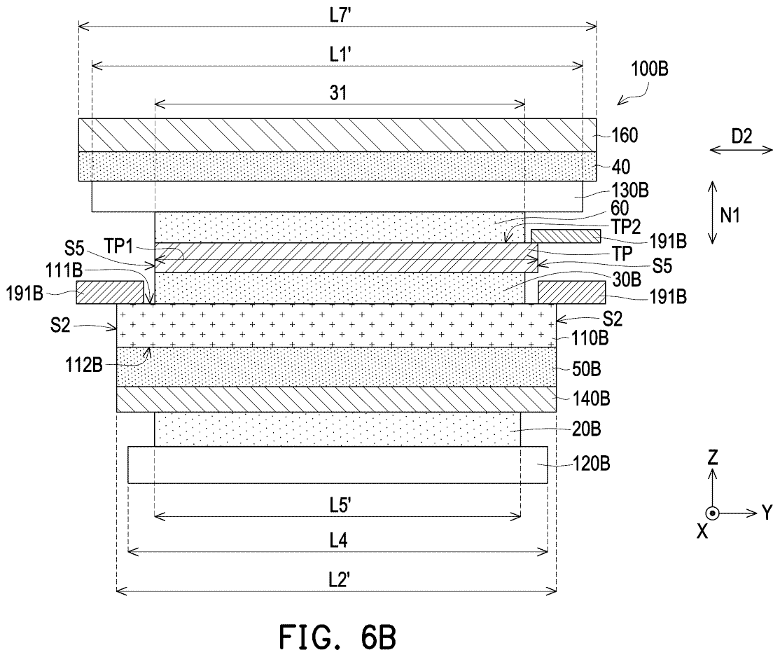

FIG. 6A and FIG. 6B are cross-sectional schematic diagrams of a display device according to an embodiment of the disclosure at different section lines. For a front view of the display device in FIG. 6A and FIG. 6B, see FIG. 3. For example, FIG. 6A is a cross-sectional schematic diagram of the display device along section line A-A′ in FIG. 3. FIG. 6B is a cross-sectional schematic diagram of the display device along section line B-B′ in FIG. 3.

First, referring to FIG. 6A, a display device 100B of this embodiment includes a substrate 120B, a first connecting element 20B, a back film 140B, a second connecting element 50B, a flexible display panel 110B, a first adhesive layer 30B, a touch panel TP, a second adhesive layer 60, a cover plate 130B, a bonding layer 40, and a protective element 160. The substrate 120B, the first connecting element 20B, the back film 140B, the second connecting element 50B, the flexible display panel 110B, the first adhesive layer 30B, the touch panel TP, the second adhesive layer 60, the cover plate 130B, the bonding layer 40, and the protective element 160 are stacked sequentially in the Z direction.

In this embodiment, the touch panel TP is located below the cover plate 130B, and the cover plate 130B provides protection. The second adhesive layer 60 is located between the touch panel TP and the cover plate 130B. The touch panel TP is adhered to the cover plate 130B using the second adhesive layer 60, but the disclosure is not limited thereto.

In this embodiment, the touch panel TP is at a top side 111B of the flexible display panel 110B, and the touch panel TP is located on the first adhesive layer 30B to avoid being shielded, but the disclosure is not limited thereto. In other embodiments, the top side 111B of the flexible display panel 110B may also be configured with an anti-reflection layer, an anti-fingerprint layer, or a hard coat, there is no limitation in the disclosure.

In this embodiment, the bonding layer 40 is located on the cover plate 130B. Specifically, the bonding layer 40 is located between the protective element 160 and the cover plate 130B, and the cover plate 130B is adhered to the protective element 160 using the bonding layer 40. Here, the protective element 160 may be a plate-shaped body made of glass, but the disclosure is not limited thereto.

In this embodiment, the flexible display panel 110B is adapted to protrude outward in the positive Z direction. The adhesive material closer to the top side 111B of the flexible display panel 110B needs to withstand greater shear strain, so placing adhesive material with a smaller storage modulus at positions that need to withstand greater shear strain reduces the chances of peeling when the adhesive material bends. Specifically, the storage modulus of the adhesive material at the top side 111B of the flexible display panel 110B is greater than the storage modulus of the adhesive material at the bottom side 112 of the flexible display panel 110B, thereby making the overall resilience of the display device 100B better.

Furthermore, the material at the top side 111B of the flexible display panel 110B is under tensile stress, and because the cover plate 130 is a relatively harder material (applying pressure), the compressive stress experienced by the second adhesive layer 60 below the cover plate 130 is greater than that of the bonding layer 40. Therefore, on the top side 111B of the flexible display panel 110B, the adhesive material layer closest to the display surface (that is, closest to the top side 111B) has the greatest ability to resist shear strain. Accordingly, the storage modulus of the adhesive material at the top side 111B of the flexible display panel 110B increases in the positive Z direction. The storage modulus of the adhesive material at the bottom side 112 of the flexible display panel 110B increases in the negative Z direction.

In one embodiment, the storage modulus of the bonding layer 40 is represented as SA, and the storage modulus of the second adhesive layer 60 is represented as SB, then 5<SA/SB<10, to avoid excessive differences in material properties, but the disclosure is not limited thereto.

Under the configuration, the storage modulus of the first adhesive layer 30B is smaller than the storage modulus of the second adhesive layer 60, the storage modulus of the second adhesive layer 60 is smaller than the storage modulus of the bonding layer 40, and the storage modulus of the second adhesive layer 60 is smaller than the storage modulus of the first connecting element 20B and the second connecting element 50B. The storage modulus of the second connecting element 50B is smaller than the storage modulus of the first connecting element 20B, and the storage modulus of the first adhesive layer 30B is between 20% and 60% of the storage modulus of the second connecting element 50B, which reduces the chances of peeling of the first adhesive layer 30B and avoid excessive differences in material properties, but the disclosure is not limited thereto.

In this embodiment, the first adhesive layer 30B, the second adhesive layer 60, and the bonding layer 40 above the flexible display panel 110B may be thin film-like Optical Clear Adhesive (OCA) or liquid-state optical clear resin. In other embodiments, the first adhesive layer 30B, the second adhesive layer 60, and the bonding layer 40 may also be non-transparent colors, there is no limitation in the disclosure. In one embodiment, the bonding layer 40 is black OCA, but there is no limitation in the disclosure.

In this embodiment, the first connecting element 20B and the second connecting element 50B below the flexible display panel 110B may be Pressure Sensitive Adhesive (PSA), double-sided tape, or adhesive element with base material in the middle, which are easy to attach and are inexpensive. In other embodiments, the first connecting element 20B and the second connecting element 50B may also be OCA, the disclosure is not limited thereto.

In detail, in one embodiment, the back film 140B, the second connecting element 50B, the flexible display panel 110B, the first adhesive layer 30B, the touch panel TP, and the second adhesive layer 60 below the cover plate 130B are cut flush with each other. In other words, the back film 140B, the second connecting element 50B, the flexible display panel 110B, the first adhesive layer 30B, the touch panel TP, and the second adhesive layer 60 have the same length L2 in the first direction D1.

Furthermore, referring to FIG. 6A, in this embodiment, the flexible display panel 110B includes two opposite first side edges S1, and the extending direction of the two first side edges S1 is parallel to the second direction D2 (that is, the Y direction). In the first direction D1, the touch panel TP includes two opposite fourth side edges S4, and the two fourth side edges S4 are parallel and cut flush with the first side edges S1.

In this embodiment, the bending axis of the flexible display panel 110B is parallel to the first direction D1, and the display surface 113 (FIG. 3) of the flexible display panel 110B corresponding to the top side 111B is adapted to protrude outward in a direction deviating from the substrate 120.

In one embodiment, the assembly steps of the display device 100 may be, for example, first configuring the back film 140B, the second connecting element 50B, the flexible display panel 110B, the first adhesive layer 30B, the touch panel TP, and the second adhesive layer 60 below the cover plate 130B, and then bonding the substrate 120B to the back film 140B through the first connecting element 20B. At this point, to avoid the first connecting element 20B being exposed/stretched due to excessive length, the first connecting element 20B is designed to be recessed. That is, in the first direction D1, the length L5 of the first connecting element 20B is smaller than the length L2 of the flexible display panel 110B and the first adhesive layer 30B above it, and the length L5 of the first connecting element 20B is smaller than the length L4 of the substrate 120B below it, but the disclosure is not limited thereto.

Referring to FIG. 6A, in the first direction D1, a length L7 of the bonding layer 40 is greater than the length L2 of the first adhesive layer 30B, the length L7 of the bonding layer 40 is greater than the length L5 of the first connecting element 20B, and the length L7 of the bonding layer 40 is greater than the length L1 of the cover plate 130B.

Referring to FIG. 6B, in one embodiment, in the second direction D2, the length of the flexible display panel 110B is greater than the length of the second adhesive layer 60, the first adhesive layer 30B, and the touch panel TP. At this point, the second adhesive layer 60 and the first adhesive layer 30B have a length 31, the touch panel TP has a length TP1, the length TP1 of the touch panel TP is greater than the length 31 of the second adhesive layer 60 and the first adhesive layer 30B, and the length TP1 of the touch panel TP is smaller than a length L2′ of the flexible display panel 110B.

Specifically, in this embodiment, the flexible display panel 110 includes two opposite second side edges S2, and the extending direction of the two second side edges S2 is parallel to the first direction D1 (that is, the X direction). The second adhesive layer 60, the first adhesive layer 30B, and the touch panel TP are recessed from the second side edges S2 of the flexible display panel 110. Thereby, the top side 111B at the left and right edges of the flexible display panel 110 is partially exposed, which may serve as a bonding position for a driving chip 191B.

In one embodiment, in the second direction D2, the length TP1 of the touch panel TP is greater than the length 31 of the second adhesive layer 60. The second adhesive layer 60 is recessed from a fifth side edge S5 of the touch panel TP. Thereby, a top side TP2 at the edge of the touch panel TP is partially exposed and may serve as the bonding position for the driving chip 191B.

In detail, in this embodiment, in the second direction D2, a length L7′ of the bonding layer 40 is greater than the length 31 of the first adhesive layer 30B, the length L7′ of the bonding layer 40 is greater than a length L5′ of the first connecting element 20B, and the length L7′ of the bonding layer 40 is greater than a length L1′ of the cover plate 130B.

More specifically, as shown in FIG. 6A, in one embodiment, in the first direction D1, the length L2 of the flexible display panel 110B is greater than the length L4 of the substrate 120, but the disclosure is not limited thereto. In other embodiments, in the first direction, the length of the flexible display panel may also be smaller than or equal to the length of the substrate, the disclosure is not limited thereto. In one embodiment, in the first direction D1, the length L2 of the second adhesive layer 60 is greater than the length L5 of the first connecting element 20B, but the disclosure is not limited thereto. In other embodiments, in the first direction, the length of the second adhesive layer may be equal to the length of the first connecting element, the disclosure is not limited thereto.

As shown in FIG. 6B, in this embodiment, in the second direction D2, the length L2′ of the flexible display panel 110B is greater than a length L4′ of the substrate 120B, but the disclosure is not limited thereto. In other embodiments, in the second direction, the length of the flexible display panel may also be smaller than or equal to the length of the substrate, the disclosure is not limited thereto. In one embodiment, in the second direction D2, the length 31 of the second adhesive layer 60 is equal to the length L5′ of the first connecting element 20B, but the disclosure is not limited thereto. In other embodiments, in the second direction, the length of the second adhesive layer may be greater than the length of the first connecting element, the disclosure is not limited thereto.

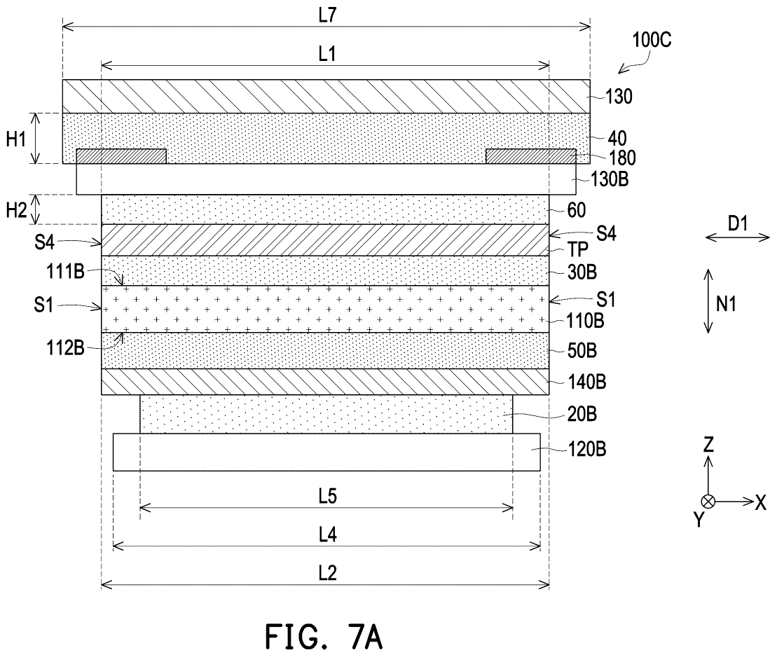

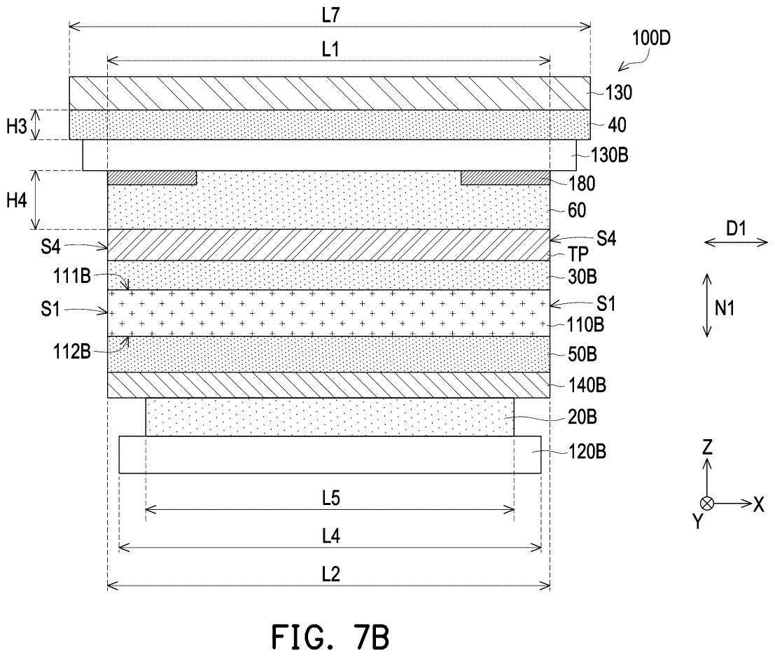

FIG. 7A is a cross-sectional schematic diagram of a display device according to an embodiment of the disclosure. Referring to FIG. 7A, in this embodiment, a display device 100C is slightly different from the display device 100B in FIG. 6A, with the main difference being: the display device 100C further includes a shield element 180, configured on the cover plate 130B, and a thickness H1 of the bonding layer 40 in the normal direction N1 is greater than a thickness H2 of the second adhesive layer 60 in the normal direction N1. Here, the shield element 180 is, for example, a Black Matrix. In the X-Y plane, the shield element 180 is, for example, distributed in a square shape, but the disclosure is not limited thereto.

FIG. 7B is a cross-sectional schematic diagram of a display device according to an embodiment of the disclosure. In this embodiment, a display device 100D is slightly different from the display device 100C in FIG. 7A, with the main difference being: the shield element 180D is configured below the cover plate 130B, and a thickness H3 of the bonding layer 40 in the normal direction N1 is smaller than a thickness H4 of the second adhesive layer 60 in the normal direction N1.

In summary, in the display device of the disclosure, the flexible display panel is adapted to protrude upward. The first adhesive layer above the flexible display panel includes two opposite third side edges, and the two third side edges are parallel and flush with the two first side edges of the flexible display panel. Thereby, when folding, the first adhesive layer completely secures the flexible display panel to the upper material. Therefore, the flexible display panel is less likely to pull the first adhesive layer to cause peeling of the first adhesive layer, thus improving yield.

It will be apparent to those skilled in the art that various modifications and variations may be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A display device, comprising:
a flexible display panel, having a top side and a bottom side opposite to each other;
a substrate, located at the bottom side and having a normal direction and a first direction and a second direction perpendicular to the normal direction, the first direction perpendicular to the second direction;
a cover plate, located at the top side;
a first connecting element, located between the substrate and the flexible display panel; and
a first adhesive layer, located between the cover plate and the flexible display panel,
wherein the flexible display panel includes two opposite first side edges and two opposite second side edges, an extending direction of the two first side edges is parallel to the second direction, and an extending direction of the two second side edges is parallel to the first direction,
a bending axis of the flexible display panel is parallel to the first direction and a display surface of the flexible display panel is adapted to protrude outward in a direction away from the substrate,
the first adhesive layer includes two opposite third side edges, and the two third side edges are parallel and flush with the two first side edges, and
in the first direction, a length of the cover plate is greater than a length of the first adhesive layer.

2. The display device according to claim 1,
wherein in the first direction, the length of the cover plate is greater than a length of the substrate.

3. The display device according to claim 1,
wherein a length of the first connecting element is smaller than or equal to a length of the flexible display panel.

4. The display device according to claim 1,
wherein a length of the first connecting element is smaller than or equal to a length of the substrate.

5. The display device according to claim 1,
wherein a length of the first connecting element is smaller than or equal to the length of the first adhesive layer.

6. The display device according to claim 1,
wherein a storage modulus of the first adhesive layer is between 20% and 60% of a storage modulus of the first connecting element.

7. The display device according to claim 1, further comprising:
a bonding layer, located on the cover plate,
wherein in the first direction and the second direction, a length of the bonding layer is greater than the length of the first adhesive layer, the length of the bonding layer is greater than a length of the first connecting element, and the length of the bonding layer is greater than the length of the cover plate.

8. The display device according to claim 7, further comprising:
a protective element,
wherein the bonding layer is located between the protective element and the cover plate.

9. The display device according to claim 7, further comprising:
a second connecting element, located between the bottom side and the first connecting element; and
a back film, located between the second connecting element and the first connecting element.

10. The display device according to claim 9, further comprising:
a touch panel, located on the first adhesive layer, the touch panel including two opposite fourth side edges, and the two fourth side edges being parallel and flush with the first side edge; and
a second adhesive layer, located between the touch panel and the cover plate, wherein in the first direction, a length of the second adhesive layer is equal to the length of the first adhesive layer.

11. The display device according to claim 10,
wherein in the second direction, a length of the flexible display panel is greater than a length of the second adhesive layer, the first adhesive layer, and the touch panel.

12. The display device according to claim 10,
wherein in the second direction, a length of the touch panel is greater than the length of the second adhesive layer.

13. The display device according to claim 10,
wherein in the first direction and the second direction, the length of the second adhesive layer is greater than or equal to the length of the first connecting element.

14. The display device according to claim 10,
wherein a storage modulus of the first adhesive layer is smaller than a storage modulus of the second adhesive layer, and the storage modulus of the second adhesive layer is smaller than a storage modulus of the first connecting element.

15. The display device according to claim 10,
wherein a storage modulus of the first adhesive layer is smaller than a storage modulus of the second adhesive layer, and the storage modulus of the second adhesive layer is smaller than a storage modulus of the second connecting element.

16. The display device according to claim 10, further comprising:
a shield element, configured on the cover plate,
wherein a thickness of the bonding layer in the normal direction is greater than a thickness of the second adhesive layer in the normal direction.

17. The display device according to claim 10, further comprising:
a shield element, configured under the cover plate,
wherein a thickness of the second adhesive layer in the normal direction is greater than a thickness of the bonding layer in the normal direction.

18. The display device according to claim 9,
wherein a storage modulus of the first adhesive layer is between 20% and 60% of a storage modulus of the second connecting element.

19. A vehicle display, comprising:
a display device, configured behind a car seat, wherein the display device comprises:
a flexible display panel, having a top side and a bottom side opposite to each other;
a substrate, located at the bottom side and having a normal direction and a first direction and a second direction perpendicular to the normal direction, the first direction perpendicular to the second direction;
a cover plate, located at the top side;
a first connecting element, located between the substrate and the flexible display panel; and
a first adhesive layer, located between the cover plate and the flexible display panel,
wherein the flexible display panel includes two opposite first side edges and two opposite second side edges, an extending direction of the two first side edges is parallel to the second direction, and an extending direction of the two second side edges is parallel to the first direction,
a bending axis of the flexible display panel is parallel to the first direction and a display surface of the flexible display panel is adapted to protrude outward in a direction away from the substrate,
the first adhesive layer includes two opposite third side edges, and the two third side edges are parallel and flush with the two first side edges, and
in the first direction, a length of the cover plate is greater than a length of the first adhesive layer.
